(19) United States
(12) Patent Application Publication
(10) Pub. No.: US 2004/0240709 A1
(43) Pub. Date: Dec. 2, 2004

(54) Method and system for controlling detail-in-context lenses through eye and position tracking

(76) Inventor: Garth Shoemaker, Vancouver (CA)

Correspondence Address: Ogilvy Renault, Suite 1600, 1981 McGill College Avenue, Montreal, QC, H3A 2Y3, CA

(21) Appl. No.: 10/825,653

(22) Filed: Apr. 16, 2004

(30) Foreign Application Priority Data
Apr. 22, 2003 (CA) 2,426,512

(51) Int. Cl. G06K 9/00; G06K 9/36; G09G 5/08; G01C 17/00; G01C 17/38

(52) U.S. Cl. 382/103; 382/291; 345/158; 702/95; 702/152

(57) ABSTRACT

A method for generating a detail-in-context presentation for an original image for display on a screen of a computer system, comprising: receiving a signal from a user through a position or eye tracking device coupled to the computer system to initiate the generation of the presentation; and, distorting the original image to produce the presentation, the presentation having a distorted region to provide the user with detailed information for a region of the original image.

This application claims priority from Canadian Patent Application No. 2,426,512, filed Apr. 22, 2003, the disclosure of which is incorporated herein by reference.

### FIELD OF THE INVENTION

This invention relates to the field of computer graphics processing, and more specifically, to a method and system for controlling detail-in-context lenses in detail-in-context presentations through eye and position tracking.

### BACKGROUND OF THE INVENTION

Modem computer graphics systems, including virtual environment systems, are used for numerous applications such as flight training, surveillance, and even playing computer games. In general, these applications are launched by the computer graphics system's operating system upon selection by a user from a menu or other graphical user interface (“GUI”). A GUI is used to convey information to and receive commands from users and generally includes a variety of GUI objects or controls, including icons, toolbars, drop-down menus, text, dialog boxes, buttons, and the like. A user typically interacts with a GUI by using a pointing device (e.g., a mouse) to position a pointer or cursor over an object and “clicking” on the object.

One problem with these computer graphics systems is their inability to effectively display detailed information for selected graphic objects when those objects are in the context of a larger image. A user may require access to detailed information with respect to an object in order to closely examine the object, to interact with the object, or to interface with an external application or network through the object. For example, the detailed information may be a close-up view of the object or a region of a digital map image.

While an application may provide a GUI for a user to access and view detailed information for a selected object in a larger image, in doing so, the relative location of the object in the larger image may be lost to the user. Thus, while the user may have gained access to the detailed information required to interact with the object, the user may lose sight of the context within which that object is positioned in the larger image. This is especially so when the user must interact with the GUI using a computer mouse or keyboard. The interaction may further distract the user from the context in which the detailed information is to be understood. This problem is an example of what is often referred to as the “screen real estate problem”.

The screen real estate problem is evident in the three-dimensional (“3D”) digitizing stylus system disclosed in U.S. Pat. No. 6,134,506 to Rosenberg, et al., and incorporated herein by reference. In Rosenberg, et al., a stylus is coupled to a computer and display through an arm-like probe device for digitizing a three-dimensional object. The digitizing process may be viewed by the user on the display. The computer receives coordinate data from the stylus describing the object. The computer uses the coordinate data to develop a representation of the object, for example, a mesh representation. The mesh representation can be displayed as the user is tracing over the object so that the user can incrementally view how the object is being represented within the computer system.

In Rosenberg, et al., the display screen can also display a user interface for selecting various options when tracing an object, entering coordinates, displaying the mesh representation, or a shaded model derived from the mesh representation (see FIG. 1 of Rosenberg, et al.). A cursor can be displayed on the screen to access functions, to manipulate the displayed mesh representation, or to access features of the stylus. The cursor can be manipulated by an input pointing device such as a mouse, trackball, touch pad, or the like, and can also be controlled by the stylus. As the stylus is moved through 3D space, the computer can receive the position data for the stylus and convert the data into two-dimensional (“2D”) coordinates. The computer can then move the cursor to those 2D coordinates on the screen as is well known. The control of the cursor by the stylus can be implemented as a mode, where the user can select whether to be in computer cursor control mode or in 3D trace mesh mode. These modes can be selected or toggled by software running on the computer by using a selection template (see FIGS. 1 and 8 of Rosenberg, et et.).

The selection template presents a collection of selection areas within the template describing options, commands, and other functions which relate to the stylus and computer. The template preferably has a thin, planar shape with a flat surface and is made out of a material such as card stock, plastic, or other durable material. Selection areas on the template can include indicia such as word commands (e.g., “start new mesh”) as well as icons, shapes, and other pictures. When a user moves the tip of the stylus onto or over a selection area of the template, a function of the stylus or control software running on the computer is implemented. For example, if the user moves the stylus onto a square icon labelled “Save Mesh”, then the 3D mesh currently displayed on the display screen is saved to a storage device coupled to the computer. A separate sensing device, such as the conventional type of contact-sensitive tablet used for detecting a stylus, is not coupled to the template to determine the functions or commands pointed to by the stylus. This is because the position and orientation of the tip of the stylus is already known to the computer through various sensors associated with the stylus and probe. The area defined by the template in the work volume of the stylus is preferably initialized in a setup procedure for the probe which determines the position and orientation of the template with respect to the base of the probe. The template and the locations of selection areas are defined in the setup procedure, so that when the tip of the stylus is pointing to those defined selection areas, the computer implements a predefined function for that selection area.

Thus, Rosenberg, et al. provides a convenient method for a user to select commands while tracing an object, since the user does not have to manipulate a separate input device, such as a mouse or trackball device, and does not have to view and move a cursor on the display screen. The user can simply touch the stylus onto the desired command. Unfortunately, the method and system of Rosenberg, et al is not practical for use with large-scale digital images such as digital maps. In particular, Rosenberg, et al. does not allow a user to generate, view, or control a detailed image within the context of a surrounding contextual image.

With respect to manipulating a separate input device to move a cursor on a display screen, often there is a need for a user to interact with a computer without the use of his or her hands. This need may arise because the user's hands are occupied while executing some task or as the result of a physical disability which prevents the user from having sufficient physical control over his or her hands to manipulate a traditional input device such as a mouse or keyboard. Interaction with a computer through eye tracking is one way to satisfy this need. For example, where a user is afflicted with severe physical disabilities, eye movements can represent one of the few remaining motions that can be readily controlled. Through eye tracking, a physically-disabled user may interact with the computer through a system able to track and respond to the motion of one or both of the user's eyes.

Typical eye tracking systems permit a user to use the eye as a control input to a computer.

In one example of such an application, identified by Gerhardt, et al. in U.S. Pat. No. 5,481,622, which is incorporated herein by reference, a user selects words from a menu on a video screen to produce synthesized speech. This system operates by determining the intersection of the eye's line of sight with the plane of the screen to determine a so-called “point of regard”, which is the point which the user is looking at on the screen and corresponds in this case to a menu selection. In other applications, however, the eye's point of regard generally corresponds to the physical point at which the eye is looking, whether on a display screen or elsewhere in three-dimensional space. The location of the point of regard is determined by the eye tracking system and used as a control input for interactive control by the user.

The eye tracking system disclosed by Gerhardt, et al. includes a helmet that supports a video camera, a video display screen, and light sources. The output of the camera is coupled to a frame grabber and a computer. The camera and light sources are positioned substantially in front of one of the user's eyes. The display screen, on the other hand, is positioned substantially in front of the user's other eye. The display screen acts as a user interface for presenting information and feedback to the user of the eye tracking system. This user interface (i.e., the display screen) provides information about the position of the user's pupil. This position may be represented on the user interface, for example, by a cursor. However, in more complicated applications such as the speech synthesis application mentioned above, the user interface may present a grid of squares to the user, which may be pre-programmed to display either characters or icons. When a user selects one of these squares, the square is highlighted to provide feedback, and an action is selected corresponding to the character or icon in that particular square. For example, each square may represent one of several actions: a link to another screen, a command message, or a special system control function. The action of linking to another screen permits menus to be chained together in order of increasing detail until a choice is made at the lowest-level screen in the chain.

In Gerhardt, et al., the camera provides an analog video output of the user's eye to the frame grabber which converts the analog video data to digital pixel data corresponding to the current image frame acquired by frame grabber from the camera. The digital pixel data output of frame grabber is transmitted to the computer for processing the pixel data to substantially determine the position of the user's pupil. After acquiring an analog image with the camera, the eye tracking system converts the image to a digital pixel representation of the image, determines a pixel intensity threshold, segments the pixel image into dark and light pixel groups, groups segmented pixels of the same intensity (i.e., dark or light) into pixel “blobs”, and selects one of these blobs as corresponding to the user's pupil. The eye tracking system then determines a user's point of regard by determining the location of the pupil blob's centroid relative a reference corner of the image, arbitrarily designated as having say a coordinate position of (0,0). Once the pupil's screen location has been determined, the screen coordinates are sent to the user interface to provide feedback to the user. For example, these coordinates may be used to display a cursor on a display screen with the position of the cursor corresponding to the point of regard of the user's eye as determined by the eye tracking system.

Unfortunately, while the eye tracking system of Gerhardt, et al. may allow a user to position a cursor on a display screen without a mouse or keyborad, it does not address the detail-in-context problem.

A need therefore exists for an improved method and system for controlling detailed views of selected information within the context of surrounding information presented on the display of a computer graphics system. Consequently, it is an object of the present invention to obviate or mitigate at least some of the above mentioned disadvantages.

### SUMMARY OF THE INVENTION

According to one aspect of the invention, there is provided a method for generating a detail-in-context presentation for an original image for display on a screen of a computer system. The method includes the steps of: receiving a signal from a user through a position tracking device coupled to the computer system to initiate the generation of the presentation; and, distorting the original image to produce the presentation, the presentation having a distorted region to provide the user with detailed information for a region of the original image.

Preferably, the step of distorting includes: establishing a lens surface for the distorted region; and, transforming the original image by applying a distortion function defining the lens surface to the original image.

Preferably, the step of transforming includes projecting the presentation onto a plane.

Preferably, the signal includes a location for the lens surface within the original image.

Preferably, the signal includes a direction for a perspective projection for the lens surface.

Preferably, the step of establishing further includes displaying a graphical user interface (“GUI”) over the distorted region for adjusting the lens surface by the user with the position tracking device.

Preferably, the lens surface includes a focal region and a shoulder region and the GUI includes at least one of: a slide bar icon for adjusting a magnification for the lens surface; a bounding rectangle icon with at least one handle icon for adjusting a size and a shape for the focal region; a bounding rectangle icon with at least one handle icon for adjusting a size and a shape for the shoulder region; a move icon for adjusting a location for the lens surface within the original image; a pickup icon for adjusting a location for the shoulder region within the original image; and, a fold icon for adjusting a location for the focal region relative to the shoulder region.

Preferably, the original image includes a two-dimensional image and a three-dimensional model.

Preferably, the position tracking device is an eye tracking device.

Preferably, the signal includes a depth for the lens surface within the original image proportional to a focal depth for the user measured by the eye tracking device.

Preferably, the screen includes a remote screen coupled to the computer system by a network.

According to another aspect of the invention, there is provided a method for adjusting a detail-in-context presentation of an original image displayed on a screen of a computer system. The method includes the steps of: receiving a signal from a user through a position tracking device coupled to the computer system to adjust the presentation; and, distorting the original image to produce an adjusted presentation for display on the screen, the adjusted presentation having a distorted region to provide the user with detailed information for a region of the original image.

Preferably, the step of distorting further includes: establishing a lens surface for the distorted region; and, transforming the original image by applying a distortion function defining the lens surface to the original image.

Preferably, the step of transforming includes projecting the adjusted presentation onto a plane.

Preferably, the signal includes an adjusted location for the lens surface within the original image.

Preferably, the signal includes an adjusted direction for a perspective projection for the lens surface.

Preferably, the step of establishing further includes displaying a graphical user interface (“GUI”) over the distorted region for adjusting the lens surface by the user with the position tracking device.

Preferably, the lens surface includes a focal region and a shoulder region and the GUI includes at least one of: a slide bar icon for adjusting a magnification for the lens surface; a bounding rectangle icon with at least one handle icon for adjusting a size and a shape for the focal region; a bounding rectangle icon with at least one handle icon for adjusting a size and a shape for the shoulder region; a move icon for adjusting a location for the lens surface within the original image; a pickup icon for adjusting a location for the shoulder region within the original image; and, a fold icon for adjusting a location for the focal region relative to the shoulder region.

Preferably, the original image includes a two-dimensional image and a three-dimensional model.

Preferably, the position tracking device is an eye tracking device.

Preferably, the signal includes a depth for the lens surface within the original image proportional to a focal depth for the user measured by the eye tracking device.

Preferably, the screen includes a remote screen coupled to the computer system by a network.

According to another aspect of the invention, there is provided a method for generating a detail-in-context presentation of a region within an original image for display on a screen of a computer system, the region including a focal region and a shoulder region. The method includes the steps of: displaying a graphical user interface (“GUI”) over the region for selecting at least one parameter for distorting at least one of the region, the focal region, and the shoulder region; receiving a signal from a user through a position tracking device coupled to the computer system for adjusting the GUI to select the at least one parameter; and, distorting the region in accordance with a distortion function and the at least one parameter to produce the presentation for display on the screen.

Preferably, the step of distorting includes projecting the adjusted presentation onto a plane.

Preferably, the at least one parameter includes a direction for a perspective projection for the distortion function.

Preferably, the at least one parameter includes at least one of: a magnification for the region; a size for the focal region; a size for the shoulder region; a shape for the focal region; a shape for the shoulder region; a location for the region within the original image; a location for the should region within the original image; and, a location for the focal region relative to the shoulder region.

Preferably, the GUI includes at least one of: a slide bar icon for selecting the at least one parameter for adjusting the magnification for the region; a bounding rectangle icon with at least one handle icon for selecting the at least one parameter for adjusting the size and the shape for the focal region; a bounding rectangle icon with at least one handle icon for selecting the at least one parameter for adjusting the size and the shape for the shoulder region; a move icon for selecting the at least one parameter for adjusting the location for the region within the original image; a pickup icon for selecting the at least one parameter for adjusting the location for the shoulder region within the original image; and, a fold icon for selecting the at least one parameter for adjusting the location for the focal region relative to the shoulder region.

Preferably, the original image includes a two-dimensional image and a three-dimensional model.

Preferably, the position tracking device is an eye tracking device.

Preferably, the signal includes a depth for the distortion function proportional to a focal depth for the user measured by the eye tracking device.

Preferably, the screen includes a remote screen coupled to the computer system by a network.

According to another aspect of the invention, there is provided a method for generating a detail-in-context presentation for an original image for display on a screen of a computer system. The method includes the steps of: receiving a signal from a user through a position tracking device coupled to the computer system to initiate the generation of the presentation; and, distorting the original image to produce the presentation, the presentation having a distorted region to provide the user with detailed information for a region of the original image; wherein the signal includes a location for the distorted region within the original image and a direction for a perspective projection for the distorted region.

Preferably, the step of distorting further includes: establishing a lens surface for the distorted region; and, transforming the original image by applying a distortion function defining the lens surface to the original image.

Preferably, the step of transforming includes projecting the adjusted presentation onto a plane.

Preferably, the step of establishing further includes displaying a graphical user interface (“GUI”) over the distorted region for adjusting the lens surface by the user with the position tracking device.

Preferably, the lens surface includes a focal region and a shoulder region and the GUI includes at least one of: a slide bar icon for adjusting a magnification for the lens surface; a bounding rectangle icon with at least one handle icon for adjusting a size and a shape for the focal region; a bounding rectangle icon with at least one handle icon for adjusting a size and a shape for the shoulder region; a move icon for adjusting a location for the lens surface within the original image; a pickup icon for adjusting a location for the shoulder region within the original image; and, a fold icon for adjusting a location for the focal region relative to the shoulder region.

Preferably, the original image includes a two-dimensional image and a three-dimensional model.

Preferably, the position tracking device is an eye tracking device.

Preferably, the signal includes a depth for the lens surface within the original image proportional to a focal depth for the user measured by the eye tracking device.

Preferably, the screen includes a remote screen coupled to the computer system by a network.

Advantageously, by using an eye or position tracking device to position and adjust detail-in-context lenses, a user can view a large area (i.e., outside the extent of the lens) while focusing in on a smaller area (or within the focal region of the lens) surrounding the selected region or object of interest. This makes it possible for a user to perceive detailed information without either losing visibility or context of the portion of the original image surrounding the selected object or being distracted by the operation of mouse-type input devices.

### BRIEF DESCRIPTION OF THE DRAWINGS

Embodiments of the invention may best be understood by referring to the following description and accompanying drawings. In the description and drawings, like numerals refer to like structures or processes. In the drawings:

FIG. 1 is a graphical representation of the geometry for constructing a three-dimensional perspective viewing frustum, relative to an x, y, z coordinate system, in accordance with known elastic presentation space graphics technology;

FIG. 2 is a graphical representation of the geometry of a presentation in accordance with known elastic presentation space graphics technology;

FIG. 3 is a block diagram illustrating a data processing system adapted for implementing an embodiment of the invention;

FIG. 4 is a partial screen capture illustrating a GUI having lens control elements for user interaction with detail-in-context data presentations in accordance with an embodiment of the invention; and,

FIG. 5 is a flow chart illustrating a method for generating a detail-in-context presentation for an original image for display on a screen of a computer system in accordance with an embodiment of the invention.

### DETAILED DESCRIPTION OF THE PREFERRED EMBODIMENTS

In the following description, numerous specific details are set forth to provide a thorough understanding of the invention. However, it is understood that the invention may be practiced without these specific details. In other instances, well-known software, circuits, structures and techniques have not been described or shown in detail in order not to obscure the invention. The term “data processing system” is used herein to refer to any machine for processing data, including the computer systems and network arrangements described herein.

The “screen real estate problem” generally arises whenever large amounts of information are to be displayed on a display screen of limited size. Known tools to address this problem include panning and zooming. While these tools are suitable for a large number of visual display applications, they become less effective where sections of the visual information are spatially related, such as in layered maps and three-dimensional representations, for example. In this type of information display, panning and zooming are not as effective as much of the context of the panned or zoomed display may be hidden.

A recent solution to this problem is the application of “detail-in-context” presentation techniques. Detail-in-context is the magnification of a particular region-of-interest (the “focal region” or “detail”) in a data presentation while preserving visibility of the surrounding information (the “context”). This technique has applicability to the display of large surface area media (e.g. digital maps) on computer screens of variable size including graphics workstations, laptop computers, personal digital assistants (“PDAs”), and cell phones.

In the detail-in-context discourse, differentiation is often made between the terms “representation” and “presentation”. A representation is a formal system, or mapping, for specifying raw information or data that is stored in a computer or data processing system. For example, a digital map of a city is a representation of raw data including street names and the relative geographic location of streets and utilities. Such a representation may be displayed visually on a computer screen or printed on paper. On the other hand, a presentation is a spatial organization of a given representation that is appropriate for the task at hand. Thus, a presentation of a representation organizes such things as the point of view and the relative emphasis of different parts or regions of the representation. For example, a digital map of a city may be presented with a region magnified to reveal street names.

In general, a detail-in-context presentation may be considered as a distorted view (or distortion) of a portion of the original representation or image where the distortion is the result of the application of a “lens” like distortion function to the original representation. A detailed review of various detail-in-context presentation techniques such as “Elastic Presentation Space” (“EPS”) (or “Pliable Display Technology” (“PDT”)) may be found in a publication by Marianne S. T. Carpendale, entitled “A Framework for Elastic Presentation Space” (Carpendale, Marianne S. T., A Framework for Elastic Presentation Space (Burnaby, British Columbia: Simon Fraser University, 1999)), and incorporated herein by reference.

In general, detail-in-context data presentations are characterized by magnification of areas of an image where detail is desired, in combination with compression of a restricted range of areas of the remaining information (i.e. the context), the result typically giving the appearance of a lens having been applied to the display surface. Using the techniques described by Carpendale, points in a representation are displaced in three dimensions and a perspective projection is used to display the points on a two-dimensional presentation display. Thus, when a lens is applied to a two-dimensional continuous surface representation, for example, the resulting presentation appears to be three-dimensional. In other words, the lens transformation appears to have stretched the continuous surface in a third dimension. In EPS graphics technology, a two-dimensional visual representation is placed onto a surface; this surface is placed in three-dimensional space; the surface, containing the representation, is viewed through perspective projection; and the surface is manipulated to effect the reorganization of image details. The presentation transformation is separated into two steps: surface manipulation or distortion and perspective projection.

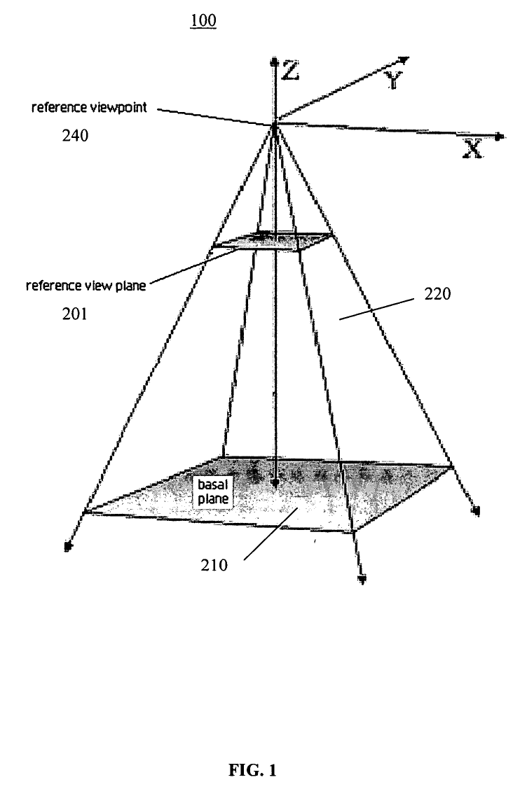

FIG. 1 is a graphical representation 100 of the geometry for constructing a three-dimensional (“3D”) perspective viewing frustum 220, relative to an x, y, z coordinate system, in accordance with known elastic presentation space (EPS) graphics technology. In EPS technology, detail-in-context views of two-dimensional (“2D”) visual representations are created with sight-line aligned distortions of a 2D information presentation surface within a 3D perspective viewing frustum 220. In EPS, magnification of regions of interest and the accompanying compression of the contextual region to accommodate this change in scale are produced by the movement of regions of the surface towards the viewpoint (“VP”) 240 located at the apex of the pyramidal shape 220 containing the frustum. The process of projecting these transformed layouts via a perspective projection results in a new 2D layout which includes the zoomed and compressed regions. The use of the third dimension and perspective distortion to provide magnification in EPS provides a meaningful metaphor for the process of distorting the information presentation surface. The 3D manipulation of the information presentation surface in such a system is an intermediate step in the process of creating a new 2D layout of the information.

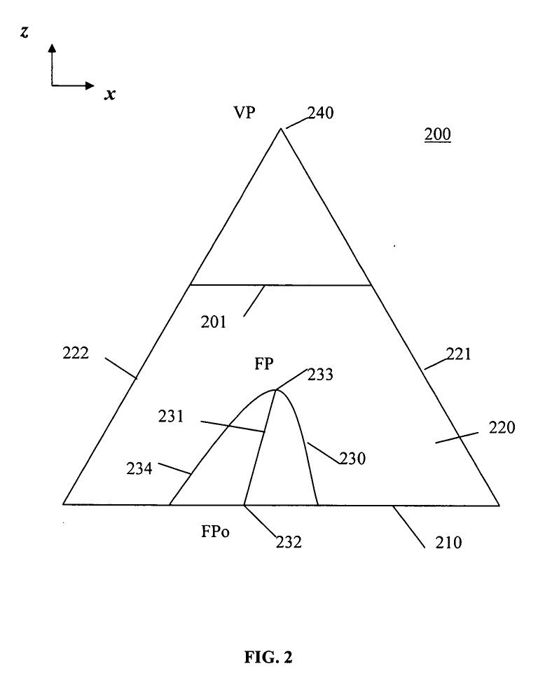

FIG. 2 is a graphical representation 200 of the geometry of a presentation in accordance with known EPS graphics technology. EPS graphics technology employs viewer-aligned perspective projections to produce detail-in-context presentations in a reference view plane 201 which may be viewed on a display. Undistorted 2D data points are located in a basal plane 210 of a 3D perspective viewing volume or frustum 220 which is defined by extreme rays 221 and 222 and the basal plane 210. The VP 240 is generally located above the centre point of the basal plane 210 and reference view plane (“RVP”) 201. Points in the basal plane 210 are displaced upward onto a distorted surface 230 which is defined by a general 3D distortion function (i.e., a detail-in-context distortion basis function). The direction of the perspective projection corresponding to the distorted surface 230 is indicated by the line FPo-FP 231 drawn from a point FPo 232 in the basal plane 210 through the point FP 233 which corresponds to the focus or focal region or focal point of the distorted surface 230. Typically, the perspective projection has a direction 231 that is viewer-aligned (i.e., the points FPo 232, FP 233, and VP 240 are collinear).

EPS is applicable to multidimensional data and is well suited to implementation on a computer for dynamic detail-in-context display on an electronic display surface such as a monitor. In the case of two dimensional data, EPS is typically characterized by magnification of areas of an image where detail is desired 233, in combination with compression of a restricted range of areas of the remaining information (i.e. the context) 234, the end result typically giving the appearance of a lens 230 having been applied to the display surface. The areas of the lens 230 where compression occurs may be referred to as the “shoulder” 234 of the lens 230. The area of the representation transformed by the lens may be referred to as the “lensed area”. The lensed area thus includes the focal region and the shoulder. To reiterate, the source image or representation to be viewed is located in the basal plane 210. Magnification 233 and compression 234 are achieved through elevating elements of the source image relative to the basal plane 210, and then projecting the resultant distorted surface onto the reference view plane 201. EPS performs detail-in-context presentation of n-dimensional data through the use of a procedure wherein the data is mapped into a region in an (n+1) dimensional space, manipulated through perspective projections in the (n+1) dimensional space, and then finally transformed back into n-dimensional space for presentation. EPS has numerous advantages over conventional zoom, pan, and scroll technologies, including the capability of preserving the visibility of information outside 234 the local region of interest 233.

For example, and referring to FIGS. 1 and 2, in two dimensions, EPS can be implemented through the projection of an image onto a reference plane 201 in the following manner. The source image or representation is located on a basal plane 210, and those regions of interest 233 of the image for which magnification is desired are elevated so as to move them closer to a reference plane situated between the reference viewpoint 240 and the reference view plane 201. Magnification of the focal region 233 closest to the RVP 201 varies inversely with distance from the RVP 201. As shown in FIGS. 1 and 2, compression of regions 234 outside the focal region 233 is a function of both distance from the RVP 201, and the gradient of the function describing the vertical distance from the RVP 201 with respect to horizontal distance from the focal region 233. The resultant combination of magnification 233 and compression 234 of the image as seen from the reference viewpoint 240 results in a lens-like effect similar to that of a magnifying glass applied to the image. Hence, the various functions used to vary the magnification and compression of the source image via vertical displacement from the basal plane 210 are described as lenses, lens types, or lens functions. Lens functions that describe basic lens types with point and circular focal regions, as well as certain more complex lenses and advanced capabilities such as folding, have previously been described by Carpendale.

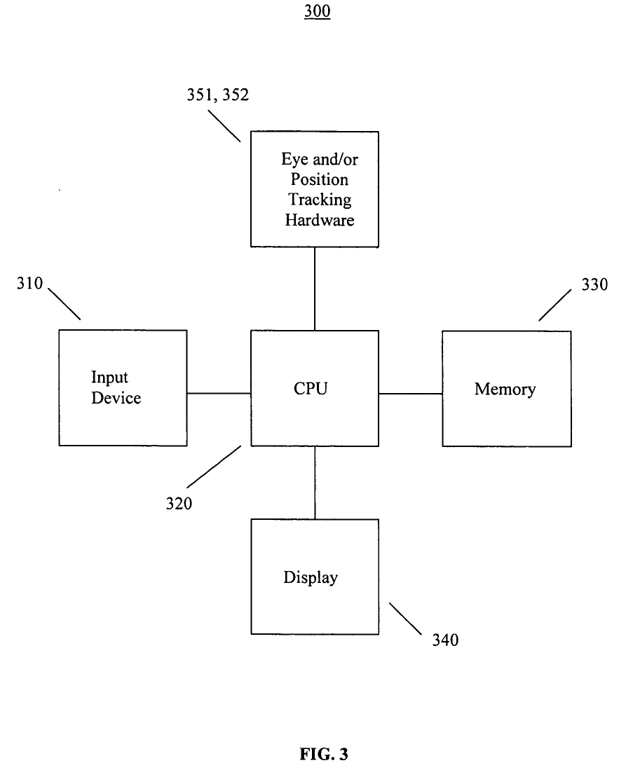

FIG. 3 is a block diagram of a data processing system 300 adapted to implement an embodiment of the invention. The data processing system 300 is suitable for implementing EPS technology, for displaying detail-in-context presentations of representations in conjunction with a detail-in-context graphical user interface (GUI) 400, as described below, and for controlling detail-in-context lenses in detail-in-context presentations through eye and position tracking. The data processing system 300 includes an input device 310, a central processing unit (“CPU”) 320, memory 330, a display 340, and an eye tracking and/or position tracking device 351, 352. The input device 310 may include a keyboard, mouse, trackball, or similar device. The CPU 320 may include dedicated coprocessors and memory devices. The memory 330 may include RAM, ROM, databases, or disk devices. The display 340 may include a computer screen, terminal device, or a hardcopy producing output device such as a printer or plotter. And, the eye tracking and/or position tracking device 351, 352 may include cameras, touch-screens, wands, and electromagnetic sensors with appropriate controllers. The data processing system 300 has stored therein data representing sequences of instructions which when executed cause the method described herein to be performed. Of course, the data processing system 300 may contain additional software and hardware a description of which is not necessary for understanding the invention.

As mentioned, detail-in-context presentations of data using techniques such as pliable surfaces, as described by Carpendale, are useful in presenting large amounts of information on limited-size display surfaces. Detail-in-context views allow magnification of a particular region-of-interest (the “focal region”) 233 in a data presentation while preserving visibility of the surrounding information 210. In the following, a GUI 400 is described having lens control elements that can be implemented in software and applied to the editing of multi-layer images and to the control of detail-in-context data presentations. The software can be loaded into and run by the data processing system 300 of FIG. 3.

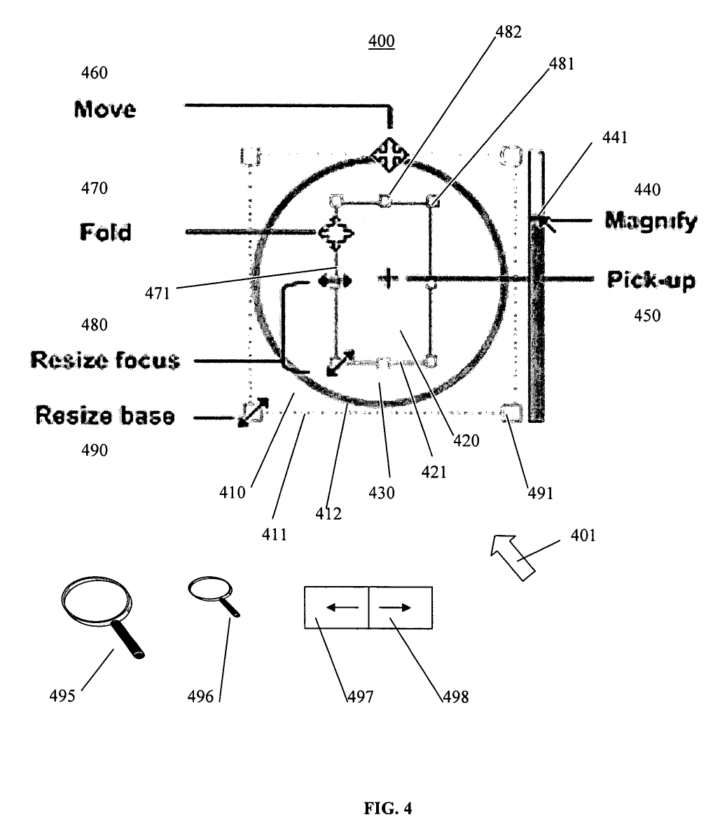

FIG. 4 is a partial screen capture illustrating a GUI 400 having lens control elements for user interaction with detail-in-context data presentations in accordance with an embodiment of the invention. Detail-in-context data presentations are characterized by magnification of areas of an image where detail is desired, in combination with compression of a restricted range of areas of the remaining information (i.e. the context), the end result typically giving the appearance of a lens having been applied to the display screen surface. This lens 410 includes a “focal region” 420 having high magnification, a surrounding “shoulder region” 430 where information is typically visibly compressed, and a “base” 412 surrounding the shoulder region 430 and defining the extent of the lens 410. In FIG. 4, the lens 410 is shown with a circular shaped base 412 (or outline) and with a focal region 420 lying near the center of the lens 410. However, the lens 410 and focal region 420 may have any desired shape. As mentioned above, the base of the lens 412 may be coextensive with the focal region 420.

In general, the GUI 400 has lens control elements that, in combination, provide for the interactive control of the lens 410. The effective control of the characteristics of the lens 410 by a user (i.e. dynamic interaction with a detail-in-context lens) is advantageous. At any given time, one or more of these lens control elements may be made visible to the user on the display surface 340 by appearing as overlay icons on the lens 410. Interaction with each element is performed via the motion of an input or pointing device 310, 351, 352 (e.g., a mouse, eye tracking device, or position tracking device) with the motion resulting in an appropriate change in the corresponding lens characteristic. As will be described, selection of which lens control element is actively controlled by the motion of the pointing device 310, 351, 352 at any given time is determined by the proximity of the icon representing the pointing device 310 (e.g. cursor) on the display surface 340 to the appropriate component of the lens 410. For example, “dragging” of the pointing device at the periphery of the bounding rectangle of the lens base 412 causes a corresponding change in the size of the lens 410 (i.e. “resizing”). Thus, the GUI 400 provides the user with a visual representation of which lens control element is being adjusted through the display of one or more corresponding icons.

For ease of understanding, the following discussion will be in the context of using a two-dimensional pointing device 310 that is a mouse, but it will be understood that the invention may be practiced with other 2D or 3D (or even greater numbers of dimensions) pointing devices including a trackball, keyboard, eye tracking device, and position tracking device.

A mouse 310 controls the position of a cursor icon 401 that is displayed on the display screen 340. The cursor 401 is moved by moving the mouse 310 over a flat surface, such as the top of a desk, in the desired direction of movement of the cursor 401. Thus, the two-dimensional movement of the mouse 310 on the flat surface translates into a corresponding two-dimensional movement of the cursor 401 on the display screen 340.

A mouse 310 typically has one or more finger actuated control buttons (i.e. mouse buttons). While the mouse buttons can be used for different functions such as selecting a menu option pointed at by the cursor 401, the disclosed invention may use a single mouse button to “select” a lens 410 and to trace the movement of the cursor 401 along a desired path. Specifically, to select a lens 410, the cursor 401 is first located within the extent of the lens 410. In other words, the cursor 401 is “pointed” at the lens 410. Next, the mouse button is depressed and released. That is, the mouse button is “clicked”. Selection is thus a point and click operation. To trace the movement of the cursor 401, the cursor 401 is located at the desired starting location, the mouse button is depressed to signal the computer 320 to activate a lens control element, and the mouse 310 is moved while maintaining the button depressed. After the desired path has been traced, the mouse button is released. This procedure is often referred to as “clicking” and “dragging” (i.e. a click and drag operation). It will be understood that a predetermined key on a keyboard 310 could also be used to activate a mouse click or drag. In the following, the term “clicking” will refer to the depression of a mouse button indicating a selection by the user and the term “dragging” will refer to the subsequent motion of the mouse 310 and cursor 401 without the release of the mouse button.

The GUI 400 may include the following lens control elements: move, pickup, resize base, resize focus, fold, magnify, zoom, and scoop. Each of these lens control elements has at least one lens control icon or alternate cursor icon associated with it. In general, when a lens 410 is selected by a user through a point and click operation, the following lens control icons may be displayed over the lens 410: pickup icon 450, base outline icon 412, base bounding rectangle icon 411, focal region bounding rectangle icon 421, handle icons 481, 482, 491 magnify slide bar icon 440, zoom icon 495, and scoop slide bar icon (not shown). Typically, these icons are displayed simultaneously after selection of the lens 410. In addition, when the cursor 401 is located within the extent of a selected lens 410, an alternate cursor icon 460, 470, 480, 490, 495 may be displayed over the lens 410 to replace the cursor 401 or may be displayed in combination with the cursor 401. These lens control elements, corresponding icons, and their effects on the characteristics of a lens 410 are described below with reference to FIG. 4.

In general, when a lens 410 is selected by a point and click operation, bounding rectangle icons 411, 421 are displayed surrounding the base 412 and focal region 420 of the selected lens 410 to indicate that the lens 410 has been selected. With respect to the bounding rectangles 411, 421 one might view them as glass windows enclosing the lens base 412 and focal region 420, respectively. The bounding rectangles 411, 421 include handle icons 481, 482, 491 allowing for direct manipulation of the enclosed base 412 and focal region 420 as will be explained below. Thus, the bounding rectangles 411, 421 not only inform the user that the lens 410 has been selected, but also provide the user with indications as to what manipulation operations might be possible for the selected lens 410 though use of the displayed handles 481, 482, 491. Note that it is well within the scope of the present invention to provide a bounding region having a shape other than generally rectangular. Such a bounding region could be of any of a great number of shapes including oblong, oval, ovoid, conical, cubic, cylindrical, polyhedral, spherical, etc.

Moreover, the cursor 401 provides a visual cue indicating the nature of an available lens control element. As such, the cursor 401 will generally change in form by simply pointing to a different lens control icon 450, 412, 411, 421, 481, 482, 491, 440. For example, when resizing the base 412 of a lens 410 using a comer handle 491, the cursor 401 will change form to a resize icon 490 once it is pointed at (i.e. positioned over) the comer handle 491. The cursor 401 will remain in the form of the resize icon 490 until the cursor 401 has been moved away from the comer handle 491.

Lateral movement of a lens 410 is provided by the move lens control element of the GUI 400. This functionality is accomplished by the user first selecting the lens 410 through a point and click operation. Then, the user points to a point within the lens 410 that is other than a point lying on a lens control icon 450, 412, 411, 421, 481, 482, 491, 440. When the cursor 401 is so located, a move icon 460 is displayed over the lens 410 to replace the cursor 401 or may be displayed in combination with the cursor 401. The move icon 460 not only informs the user that the lens 410 may be moved, but also provides the user with indications as to what movement operations are possible for the selected lens 410. For example, the move icon 460 may include arrowheads indicating up, down, left, and right motion. Next, the lens 410 is moved by a click and drag operation in which the user clicks and drags the lens 410 to the desired position on the screen 340 and then releases the mouse button 310. The lens 410 is locked in its new position until a further pickup and move operation is performed.

Lateral movement of a lens 410 is also provided by the pickup lens control element of the GUI. This functionality is accomplished by the user first selecting the lens 410 through a point and click operation. As mentioned above, when the lens 410 is selected a pickup icon 450 is displayed over the lens 410 near the centre of the lens 410. Typically, the pickup icon 450 will be a crosshairs. In addition, a base outline 412 is displayed over the lens 410 representing the base 412 of the lens 410. The crosshairs 450 and lens outline 412 not only inform the user that the lens has been selected, but also provides the user with an indication as to the pickup operation that is possible for the selected lens 410. Next, the user points at the crosshairs 450 with the cursor 401. Then, the lens outline 412 is moved by a click and drag operation in which the user clicks and drags the crosshairs 450 to the desired position on the screen 340 and then releases the mouse button 310. The full lens 410 is then moved to the new position and is locked there until a further pickup operation is performed. In contrast to the move operation described above, with the pickup operation, it is the outline 412 of the lens 410 that the user repositions rather than the full lens 410.

Resizing of the base 412 (or outline) of a lens 410 is provided by the resize base lens control element of the GUI. After the lens 410 is selected, a bounding rectangle icon 411 is displayed surrounding the base 412. For a rectangular shaped base 412, the bounding rectangle icon 411 may be coextensive with the perimeter of the base 412. The bounding rectangle 411 includes handles 491. These handles 491 can be used to stretch the base 412 taller or shorter, wider or narrower, or proportionally larger or smaller. The comer handles 491 will keep the proportions the same while changing the size. The middle handles (not shown) will make the base 412 taller or shorter, wider or narrower. Resizing the base 412 by the corner handles 491 will keep the base 412 in proportion. Resizing the base 412 by the middle handles will change the proportions of the base 412. That is, the middle handles change the aspect ratio of the base 412 (i.e. the ratio between the height and the width of the bounding rectangle 411 of the base 412). When a user points at a handle 491 with the cursor 401 a resize icon 490 may be displayed over the handle 491 to replace the cursor 401 or may be displayed in combination with the cursor 401. The resize icon 490 not only informs the user that the handle 491 may be selected, but also provides the user with indications as to the resizing operations that are possible with the selected handle. For example, the resize icon 490 for a comer handle 491 may include arrows indicating proportional resizing. The resize icon (not shown) for a middle handle may include arrows indicating width resizing or height resizing. After pointing at the desired handle 491 the user would click and drag the handle 491 until the desired shape and size for the base 412 is reached. Once the desired shape and size are reached, the user would release the mouse button 310. The base 412 of the lens 410 is then locked in its new size and shape until a further base resize operation is performed.

Resizing of the focal region 420 of a lens 410 is provided by the resize focus lens control element of the GUI. After the lens 410 is selected, a bounding rectangle icon 421 is displayed surrounding the focal region 420. For a rectangular shaped focal region 420, the bounding rectangle icon 421 may be coextensive with the perimeter of the focal region 420. The bounding rectangle 421 includes handles 481, 482. These handles 481, 482 can be used to stretch the focal region 420 taller or shorter, wider or narrower, or proportionally larger or smaller. The comer handles 481 will keep the proportions the same while changing the size. The middle handles 482 will make the focal region 420 taller or shorter, wider or narrower. Resizing the focal region 420 by the comer handles 481 will keep the focal region 420 in proportion. Resizing the focal region 420 by the middle handles 482 will change the proportions of the focal region 420. That is, the middle handles 482 change the aspect ratio of the focal region 420 (i.e. the ratio between the height and the width of the bounding rectangle 421 of the focal region 420). When a user points at a handle 481, 482 with the cursor 401 a resize icon 480 may be displayed over the handle 481, 482 to replace the cursor 401 or may be displayed in combination with the cursor 401. The resize icon 480 not only informs the user that a handle 481, 482 may be selected, but also provides the user with indications as to the resizing operations that are possible with the selected handle. For example, the resize icon 480 for a comer handle 481 may include arrows indicating proportional resizing. The resize icon 480 for a middle handle 482 may include arrows indicating width resizing or height resizing. After pointing at the desired handle 481, 482, the user would click and drag the handle 481, 482 until the desired shape and size for the focal region 420 is reached. Once the desired shape and size are reached, the user would release the mouse button 310. The focal region 420 is then locked in its new size and shape until a further focus resize operation is performed.

Folding of the focal region 420 of a lens 410 is provided by the fold control element of the GUI. In general, control of the degree and direction of folding (i.e. skewing of the viewer aligned vector 231 as described by Carpendale) is accomplished by a click and drag operation on a point 471, other than a handle 481, 482, on the bounding rectangle 421 surrounding the focal region 420. The direction of folding is determined by the direction in which the point 471 is dragged. The degree of folding is determined by the magnitude of the translation of the cursor 401 during the drag. In general, the direction and degree of folding corresponds to the relative displacement of the focus 420 with respect to the lens base 410. In other words, and referring to FIG. 2, the direction and degree of folding corresponds to the displacement of the point FP 233 relative to the point FPo 232, where the vector joining the points FPo 232 and FP 233 defines the viewer aligned vector 231. In particular, after the lens 410 is selected, a bounding rectangle icon 421 is displayed surrounding the focal region 420. The bounding rectangle 421 includes handles 481, 482. When a user points at a point 471, other than a handle 481, 482, on the bounding rectangle 421 surrounding the focal region 420 with the cursor 401, a fold icon 470 may be displayed over the point 471 to replace the cursor 401 or may be displayed in combination with the cursor 401. The fold icon 470 not only informs the user that a point 471 on the bounding rectangle 421 may be selected, but also provides the user with indications as to what fold operations are possible. For example, the fold icon 470 may include arrowheads indicating up, down, left, and right motion. By choosing a point 471, other than a handle 481, 482, on the bounding rectangle 421 a user may control the degree and direction of folding. To control the direction of folding, the user would click on the point 471 and drag in the desired direction of folding. To control the degree of folding, the user would drag to a greater or lesser degree in the desired direction of folding. Once the desired direction and degree of folding is reached, the user would release the mouse button 310. The lens 410 is then locked with the selected fold until a further fold operation is performed.

Magnification of the lens 410 is provided by the magnify lens control element of the GUI. After the lens 410 is selected, the magnify control is presented to the user as a slide bar icon 440 near or adjacent to the lens 410 and typically to one side of the lens 410. Sliding the bar 441 of the slide bar 440 results in a proportional change in the magnification of the lens 410. The slide bar 440 not only informs the user that magnification of the lens 410 may be selected, but also provides the user with an indication as to what level of magnification is possible. The slide bar 440 includes a bar 441 that may be slid up and down, or left and right, to adjust and indicate the level of magnification. To control the level of magnification, the user would click on the bar 441 of the slide bar 440 and drag in the direction of desired magnification level. Once the desired level of magnification is reached, the user would release the mouse button 310. The lens 410 is then locked with the selected magnification until a further magnification operation is performed. In general, the focal region 420 is an area of the lens 410 having constant magnification (i.e. if the focal region is a plane). Again referring to FIGS. 1 and 2, magnification of the focal region 420, 233 varies inversely with the distance from the focal region 420, 233 to the reference view plane (RVP) 201. Magnification of areas lying in the shoulder region 430 of the lens 410 also varies inversely with their distance from the RVP 201. Thus, magnification of areas lying in the shoulder region 430 will range from unity at the base 412 to the level of magnification of the focal region 420.

Zoom functionality is provided by the zoom lens control element of the GUI. Referring to FIG. 2, the zoom lens control element, for example, allows a user to quickly navigate to a region of interest 233 within a continuous view of a larger presentation 210 and then zoom in to that region of interest 233 for detailed viewing or editing. Referring to FIG. 4, the combined presentation area covered by the focal region 420 and shoulder region 430 and surrounded by the base 412 may be referred to as the “extent of the lens”. Similarly, the presentation area covered by the focal region 420 may be referred to as the “extent of the focal region”. The extent of the lens may be indicated to a user by a base bounding rectangle 411 when the lens 410 is selected. The extent of the lens may also be indicated by an arbitrarily shaped figure that bounds or is coincident with the perimeter of the base 412. Similarly, the extent of the focal region may be indicated by a second bounding rectangle 421 or arbitrarily shaped figure. The zoom lens control element allows a user to: (a) “zoom in” to the extent of the focal region such that the extent of the focal region fills the display screen 340 (i.e. “zoom to focal region extent”); (b) “zoom in” to the extent of the lens such that the extent of the lens fills the display screen 340 (i.e. “zoom to lens extent”); or, (c) “zoom in” to the area lying outside of the extent of the focal region such that the area without the focal region is magnified to the same level as the extent of the focal region (i.e. “zoom to scale”).

In particular, after the lens 410 is selected, a bounding rectangle icon 411 is displayed surrounding the base 412 and a bounding rectangle icon 421 is displayed surrounding the focal region 420. Zoom functionality is accomplished by the user first selecting the zoom icon 495 through a point and click operation When a user selects zoom functionality, a zoom cursor icon 496 may be displayed to replace the cursor 401 or may be displayed in combination with the cursor 401. The zoom cursor icon 496 provides the user with indications as to what zoom operations are possible. For example, the zoom cursor icon 496 may include a magnifying glass. By choosing a point within the extent of the focal region, within the extent of the lens, or without the extent of the lens, the user may control the zoom function. To zoom in to the extent of the focal region such that the extent of the focal region fills the display screen 340 (i.e. “zoom to focal region extent”), the user would point and click within the extent of the focal region. To zoom in to the extent of the lens such that the extent of the lens fills the display screen 340 (i.e. “zoom to lens extent”), the user would point and click within the extent of the lens. Or, to zoom in to the presentation area without the extent of the focal region, such that the area without the extent of the focal region is magnified to the same level as the extent of the focal region (i.e. “zoom to scale”), the user would point and click without the extent of the lens. After the point and click operation is complete, the presentation is locked with the selected zoom until a further zoom operation is performed.

Alternatively, rather than choosing a point within the extent of the focal region, within the extent of the lens, or without the extent of the lens to select the zoom function, a zoom function menu with multiple items (not shown) or multiple zoom function icons (not shown) may be used for zoom function selection. The zoom function menu may be presented as a pull-down menu. The zoom function icons may be presented in a toolbar or adjacent to the lens 410 when the lens is selected. Individual zoom function menu items or zoom function icons may be provided for each of the “zoom to focal region extent”, “zoom to lens extent”, and “zoom to scale” functions described above. In this alternative, after the lens 410 is selected, a bounding rectangle icon 411 may be displayed surrounding the base 412 and a bounding rectangle icon 421 may be displayed surrounding the focal region 420. Zoom functionality is accomplished by the user selecting a zoom function from the zoom function menu or via the zoom function icons using a point and click operation. In this way, a zoom function may be selected without considering the position of the cursor 401 within the lens 410.

The concavity or “scoop” of the shoulder region 430 of the lens 410 is provided by the scoop lens control element of the GUI. After the lens 410 is selected, the scoop control is presented to the user as a slide bar icon (not shown) near or adjacent to the lens 410 and typically below the lens 410. Sliding the bar (not shown) of the slide bar results in a proportional change in the concavity or scoop of the shoulder region 430 of the lens 410. The slide bar not only informs the user that the shape of the shoulder region 430 of the lens 410 may be selected, but also provides the user with an indication as to what degree of shaping is possible. The slide bar includes a bar that may be slid left and right, or up and down, to adjust and indicate the degree of scooping. To control the degree of scooping, the user would click on the bar of the slide bar and drag in the direction of desired scooping degree. Once the desired degree of scooping is reached, the user would release the mouse button 310. The lens 410 is then locked with the selected scoop until a further scooping operation is performed.

Advantageously, a user may choose to hide one or more lens control icons 450, 412, 411, 421, 481, 482, 491, 440, 495 shown in FIG. 4 from view so as not to impede the user's view of the image within the lens 410. This may be helpful, for example, during an editing or move operation. A user may select this option through means such as a menu, toolbar, or lens property dialog box.

In addition, the GUI 400 maintains a record of control element operations such that the user may restore pre-operation presentations. This record of operations may be accessed by or presented to the user through “Undo” and “Redo” icons 497, 498, through a pull-down operation history menu (not shown), or through a toolbar.

Thus, detail-in-context data viewing techniques allow a user to view multiple levels of detail or resolution on one display 340. The appearance of the data display or presentation is that of one or more virtual lenses showing detail 233 within the context of a larger area view 210. Using multiple lenses in detail-in-context data presentations may be used to compare two regions of interest at the same time. Folding enhances this comparison by allowing the user to pull the regions of interest closer together. Moreover, using detail-in-context technology such as PDT, an area of interest can be magnified to pixel level resolution, or to any level of detail available from the source information, for in-depth review. The digital images may include graphic images, maps, photographic images, or text documents, and the source information may be in raster, vector, or text form.

For example, in order to view a selected object or area in detail, a user can define a lens 410 over the object using the GUI 400. The lens 410 may be introduced to the original image to form the a presentation through the use of a pull-down menu selection, tool bar icon, etc. Using lens control elements for the GUI 400, such as move, pickup, resize base, resize focus, fold, magnify, zoom, and scoop, as described above, the user adjusts the lens 410 for detailed viewing of the object or area. Using the magnify lens control element, for example, the user may magnify the focal region 420 of the lens 410 to pixel quality resolution revealing detailed information pertaining to the selected object or area. That is, a base image (i.e., the image outside the extent of the lens) is displayed at a low resolution while a lens image (i.e., the image within the extent of the lens) is displayed at a resolution based on a user selected magnification 440, 441.

In operation, the data processing system 300 employs EPS techniques with an input device 310 and GUI 400 for selecting objects or areas for detailed display to a user on a display screen 340. Data representing an original image or representation is received by the CPU 320 of the data processing system 300. Using EPS techniques, the CPU 320 processes the data in accordance with instructions received from the user via an input device 310 and GUI 400 to produce a detail-in-context presentation. The presentation is presented to the user on a display screen 340. It will be understood that the CPU 320 may apply a transformation to the shoulder region 430 surrounding the region-of-interest 420 to affect blending or folding in accordance with EPS technology. For example, the transformation may map the region-of-interest 420 and/or shoulder region 430 to a predefined lens surface, defined by a transformation or distortion function and having a variety of shapes, using EPS techniques. Or, the lens 410 may be simply coextensive with the region-of-interest 420.

The lens control elements of the GUI 400 are adjusted by the user via an input device 310 to control the characteristics of the lens 410 in the detail-in-context presentation. Using an input device 310 such as a mouse, a user adjusts parameters of the lens 410 using icons and scroll bars of the GUI 400 that are displayed over the lens 410 on the display screen 340. The user may also adjust parameters of the image of the full scene. Signals representing input device 310 movements and selections are transmitted to the CPU 320 of the data processing system 300 where they are translated into instructions for lens control.

Moreover, the lens 410 may be added to the presentation before or after the object or area is selected. That is, the user may first add a lens 410 to a presentation or the user may move a pre-existing lens into place over the selected object or area. The lens 410 may be introduced to the original image to form the presentation through the use of a pull-down menu selection, tool bar icon, etc.

Advantageously, by using a detail-in-context lens 410 to select an object or area for detailed information gathering, a user can view a large area (i.e., outside the extent of the lens 410) while focusing in on a smaller area (or within the focal region 420 of the lens 410) surrounding the selected object. This makes it possible for a user to accurately gather detailed information without losing visibility or context of the portion of the original image surrounding the selected object.

Now, according to the present invention, a method is provided for controlling detail-in-context lens through eye and position tracking. As mentioned, detail-in-context viewing is a technique applicable to 2D or 3D data that allows for data to be magnified locally while maintaining data continuity. In two dimensions, an arbitrarily shaped region of interest is magnified in place within the data, while a surrounding band of variable magnification connects the region of interest with the surrounding image. The magnified region is referred to as the focal region 420, the surrounding band of variable magnification is referred to as the shoulder region 430, and the surrounding image is referred to as the “base image” (i.e., the region beyond the base 412). The focal region 420 and shoulder region 430 together comprise the lens 410. When applied to 3D data, the lens concept itself can be extended into three dimensions. The lens 410 typically takes the form of a cylinder (although it can take on other forms) of magnification that extends from the viewpoint 240 through the region-of-interest 233 in the data. The cylinder of magnification can be of finite or infinite depth. The magnification cylinder can act on the data by magnifying objects, displacing objects, or deforming individual objects. In either 2D or 3D, it is desirable to have a method of positioning and manipulating the lens 410. Such parameters as lens position, lens size, and lens magnification may need to be adjusted by the user. The present invention allows a user to manipulate lens parameters 450, 412, 411, 421, 481, 482, 491, 440, 495 through the use of eye tracking and/or position tracking devices 351, 352 and technology.

According to one aspect of the invention, a method is provided for controlling detail-in-context lens through eye tracking. As discussed above, an eye tracking device 351 typically includes of one or more cameras (not shown) that survey a scene, identify the eyes of a user in the scene, and through a technique such as pattern recognition determine the direction in which the user's eyes are focused. For desktop applications, the camera is typically positioned on the user's desk near the system display 340 and is pointed towards the chair in which a user would sit. When the user sits at the chair and uses the computer system 300, the eye tracking device 351 identifies the point on the display 340 at which the user is looking. The present invention combines desktop eye tracking with detail-in-context viewing for both 2D and 3D lenses.

The eye tracking device 351 is able to determine the point on the display 340 at which a user is looking. With a detail-in-context lens 410 presented on the display 340, it is possible to position the lens 410 at the location on the display 340 that the user is looking at through eye tracking. In other words, rather than using a mouse 310 to position the lens 410 using the move or pickup lens control elements described above, an eye tracking device 351 is used to perform this operation. Eye tracking can be used to manipulate parameters other than lens position. For example, the eye gaze point of interest and eye movement can be used to change parameters such as lens size and magnification level using the resize base, resize focus, and magnification lens control elements described above. Eye gestures can be used to change mode or perform operations on the lens 410. For example, a prolonged blink or similar gesture can be used to activate or deactivate a lens rather than using a pull-down menu or tool bar icon, for example, to introduce a lens to a presentation. As the human gaze tends to include a certain amount of “noise” (i.e., unintended minor fluctuations in gaze direction), the eye tracking device 351 can apply a movement damping function to its output for manipulating lens parameters.

The method of controlling detail-in-context lens parameters of the present invention may be readily applied in large screen applications. For example, the combined use of eye tracking and detail-in-context lenses can be applied to large displays including wall-mounted displays or digital whiteboards. In addition, the combined use of eye tracking and detail-in-context lenses can be used by multiple users interacting with a single screen. In this case, for example, one lens could be manipulated per user. In addition, the position and state of a lens as determined by gaze direction from the eye tracking device 351 can be transmitted over a network to a remote computer or display in order to impart an awareness to the remote user of the gaze direction of the local user. This may be referred to as “remote gaze awareness”.

The method described above for use in desktop and large screen environments can be extended to use in immersive virtual reality environments. In this case, instead of the eye tracking device 351 determining the point-of-interest on the screen through eye tracking, it determines the direction of gaze through a virtual environment. This can be used to position and manipulate lenses. Furthermore, the use of an eye tracking device 351 that can detect focal depth (i.e., through the tracking of both eyes of a user) can be used to position a lens 410 at a depth defined by the focal depth.

According to another aspect of the present invention, a method is provided for controlling detail-in-context lens through position tracking. As mentioned above, there are a variety of technologies that allow for the tracking of physical objects in 3D. These technologies include camera technologies that track objects through optical recognition and magnetic technologies that track sensors through measurement of magnetic fields. According to this aspect of the invention, rather than using a mouse 310, a position tracking device 352 that outputs measurements of position, orientation, and movement of an associated object controlled by a user, is used to manipulate detail-in-context lenses.

With a detail-in-context lens 410 presented on the display 340, it is possible to position the lens 410 at the location on the display 340 that the user is interested in through position tracking. In other words, rather than using a mouse 310 to position the lens 410 using the move or pickup lens control elements described above, a position tracking device 352 is used to perform this operation. Position tracking can be used to manipulate parameters other than lens position.

Consider a 2D map presented on a display screen 340 that is being examined by a user. One or more sensors associated with the position tracking device 352 detect the position and orientation of the user's finger. For example, the user may attach a sensor to his or her finger. When the user points at a location on the screen, through position tracking a lens 410 appears at that point. If the user points at a different location, the lens moves to that location.

Now consider a user who is examining a 3D model on a screen 340. Again, sensors associated with the position tracking device detect the position and orientation of the user's finger. When the user points at a location on the screen, a 3D lens is inserted in the data, originating from the tip of the finger, and progressing through the data in a direction determined by the finger's orientation. Thus, the direction of the perspective projection 231 corresponding to the lens 230 may be determined by the orientation of the user's finger (or other user controlled object tracked by the position tracking device 352).

Similarly, consider a user in an immersive virtual reality environment who is observing a 3D model floating within reach. When the user reaches out and “touches” a finger to the model at a region-of-interest, a 3D lens can be inserted in the model at the point touched by the user, oriented towards the user's point of view 240. Thus, a viewer-aligned direction for the perspective projection 231 corresponding to the lens 230 is selected.

Of course the position tracking device 352 can be used to track objects other than a user's finger (and associated sensors). For example, the position tracking device 352 can track other user controlled objects including wands, remote controllers, and laser pens.

Thus, in operation, the data processing system 300 employs EPS techniques with an eye or position tracking device 351, 352 and GUI 400 for selecting objects or areas for detailed display to a user on a display screen 340. Data representing an original image or representation is received by the CPU 320 of the data processing system 300. Using EPS techniques, the CPU 320 processes the data in accordance with instructions received from the user via the eye or position tracking device 351, 352 and GUI 400 to produce a detail-in-context presentation. The presentation is presented to the user on a display screen 340. The lens control elements of the GUI 400 are adjusted by the user via the eye or position tracking device 351, 352 to control the characteristics of the lens 410 in the detail-in-context presentation. Using the eye or position tracking device 351, 352, a user adjusts parameters of the lens 410 using icons and scroll bars of the GUI 400 that are displayed over the lens 410 on the display screen 340. The user may also adjust parameters of the image of the full scene. Signals representing the eye or position tracking device 351, 352 movements and selections are transmitted to the CPU 320 of the data processing system 300 where they are translated into instructions for lens control.

In addition, the lens 410 may be added to the presentation before or after the object or area is selected. That is, the user may first add a lens 410 to a presentation or the user may move a pre-existing lens into place over the selected object or area. The lens 410 may be introduced to the original image to form the presentation through the use of a pull-down menu selection, tool bar icon, blink of the eye, predetermined sensor movement, etc.

Advantageously, by using an eye or position tracking device 351, 352 to position and adjust detail-in-context lenses 410, a user can view a large area (i.e., outside the extent of the lens 410) while focusing in on a smaller area (or within the focal region 420 of the lens 410) surrounding the selected region or object of interest. This makes it possible for a user to perceive detailed information without either losing visibility or context of the portion of the original image surrounding the selected object or being distracted by the operation of mouse-type input devices 310.

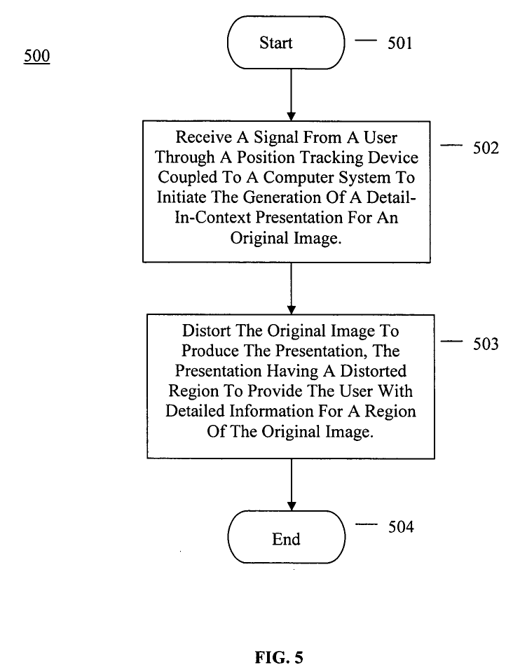

FIG. 5 is a flow chart 500 illustrating a method for generating a detail-in-context presentation for an original image for display on a screen 340 of a computer system 300 in accordance with an embodiment of the invention. At step 501, the method starts.

At step 502, a signal is received from a user through a position tracking device 352 coupled to the computer system 300 to initiate the generation of the presentation. The original image may include a two-dimensional image and a three-dimensional model. The position tracking device 352 may be an eye tracking device 351. The signal may include a depth for the lens surface within the original image proportional to a focal depth for the user measured by the eye tracking device 351. And, the screen 340 may include a remote screen coupled to the computer system 300 by a network.

At step 503, the original image is distorted to produce the presentation, the presentation having a distorted region 410 to provide the user with detailed information for a region of the original image. The step of distorting may include: establishing a lens surface 230 for the distorted region; and, transforming the original image by applying a distortion function defining the lens surface 230 to the original image. The step of transforming may include projecting the presentation onto a plane 201. The signal may include a location for the lens surface 410 within the original image and a direction for a perspective projection 231 for the lens surface 230. The step of establishing may further include displaying a graphical user interface (“GUI”) 400 over the distorted region 410 for adjusting the lens surface 230 by the user with the position tracking device 352. And, the lens surface 230 may include a focal region 233, 420 and a shoulder region 234, 430 and the GUI 400 may include at least one of: a slide bar icon 440 for adjusting a magnification for the lens surface 230; a bounding rectangle icon 421 with at least one handle icon 481, 482 for adjusting a size and a shape for the focal region 420; a bounding rectangle icon 411 with at least one handle icon 491 for adjusting a size and a shape for the shoulder region 430; a move icon 460 for adjusting a location for the lens surface 230 within the original image; a pickup icon 450 for adjusting a location for the shoulder region 430 within the original image; and, a fold icon 470 for adjusting a location for the focal region 420 relative to the shoulder region 430.

At step 504, the method ends.

The sequences of instructions which when executed cause the method described herein to be performed by the exemplary data processing system 300 of FIG. 3 can be contained in a data carrier product according to one embodiment of the invention. This data carrier product can be loaded into and run by the exemplary data processing system 300 of FIG. 3.

The sequences of instructions which when executed cause the method described herein to be performed by the exemplary data processing system 300 of FIG. 3 can be contained in a computer software product according to one embodiment of the invention. This computer software product can be loaded into and run by the exemplary data processing system 300 of FIG. 3.

The sequences of instructions which when executed cause the method described herein to be performed by the exemplary data processing system 300 of FIG. 3 can be contained in an integrated circuit product including a coprocessor or memory according to one embodiment of the invention. This integrated circuit product can be installed in the exemplary data processing system 300 of FIG. 3.

Although preferred embodiments of the invention have been described herein, it will be understood by those skilled in the art that variations may be made thereto without departing from the spirit of the invention or the scope of the appended claims.

What is claimed is:

1. A method for generating a detail-in-context presentation for an original image for display on a screen of a computer system, comprising:
receiving a signal from a user through a position tracking device coupled to the computer system to initiate the generation of the presentation; and,
distorting the original image to produce the presentation, the presentation having a distorted region to provide the user with detailed information for a region of the original image.

2. The method of claim 1 wherein the distorting includes:
establishing a lens surface for the distorted region; and,
transforming the original image by applying a distortion function defining the lens surface to the original image.

3. The method of claim 2 wherein the transforming includes projecting the presentation onto a plane.

4. The method of claim 3 wherein the signal includes a location for the lens surface within the original image.

5. The method of claim 3 wherein the signal includes a direction for a perspective projection for the lens surface.

6. The method of claim 3 wherein the establishing further includes displaying a graphical user interface (“GUI”) over the distorted region for adjusting the lens surface by the user with the position tracking device.

7. The method of claim 6 wherein the lens surface includes a focal region and a shoulder region and the GUI includes at least one of: a slide bar icon for adjusting a magnification for the lens surface; a bounding rectangle icon with at least one handle icon for adjusting a size and a shape for the focal region; a bounding rectangle icon with at least one handle icon for adjusting a size and a shape for the shoulder region; a move icon for adjusting a location for the lens surface within the original image; a pickup icon for adjusting a location for the shoulder region within the original image; and, a fold icon for adjusting a location for the focal region relative to the shoulder region.

8. The method of claim 1 wherein the original image includes a two-dimensional image and a three-dimensional model.

9. The method of claim 1 wherein the position tracking device is an eye tracking device.

10. The method of claim 3 wherein the position tracking device is an eye tracking device and wherein the signal includes a depth for the lens surface within the original image proportional to a focal depth for the user measured by the eye tracking device.

11. The method of claim 1 wherein the screen includes a remote screen coupled to the computer system by a network.

12. A method for adjusting a detail-in-context presentation of an original image displayed on a screen of a computer system, comprising:
receiving a signal from a user through a position tracking device coupled to the computer system to adjust the presentation; and,
distorting the original image to produce an adjusted presentation for display on the screen, the adjusted presentation having a distorted region to provide the user with detailed information for a region of the original image.

13. The method of claim 12 wherein the distorting further includes:
establishing a lens surface for the distorted region; and,
transforming the original image by applying a distortion function defining the lens surface to the original image.

14. The method of claim 13 wherein the transforming includes projecting the adjusted presentation onto a plane.

15. The method of claim 14 wherein the signal includes an adjusted location for the lens surface within the original image.

16. The method of claim 14 wherein the signal includes an adjusted direction for a perspective projection for the lens surface.

17. The method of claim 13 wherein the establishing further includes displaying a graphical user interface (“GUI”) over the distorted region for adjusting the lens surface by the user with the position tracking device.

18. The method of claim 17 wherein the lens surface includes a focal region and a shoulder region and the GUI includes at least one of: a slide bar icon for adjusting a magnification for the lens surface; a bounding rectangle icon with at least one handle icon for adjusting a size and a shape for the focal region; a bounding rectangle icon with at least one handle icon for adjusting a size and a shape for the shoulder region; a move icon for adjusting a location for the lens surface within the original image; a pickup icon for adjusting a location for the shoulder region within the original image; and, a fold icon for adjusting a location for the focal region relative to the shoulder region.

19. The method of claim 12 wherein the original image includes a two-dimensional image and a three-dimensional model.

20. The method of claim 12 wherein the position tracking device is an eye tracking device.

21. The method of claim 14 wherein the position tracking device is an eye tracking device and wherein the signal includes a depth for the lens surface within the original image proportional to a focal depth for the user measured by the eye tracking device.

22. The method of claim 12 wherein the screen includes a remote screen coupled to the computer system by a network.

23. A method for generating a detail-in-context presentation of a region within an original image for display on a screen of a computer system, the region including a focal region and a shoulder region, comprising:
displaying a graphical user interface (“GUI”) over the region for selecting at least one parameter for distorting at least one of the region, the focal region, and the shoulder region;
receiving a signal from a user through a position tracking device coupled to the computer system for adjusting the GUI to select the at least one parameter; and,
distorting the region in accordance with a distortion function and the at least one parameter to produce the presentation for display on the screen.

24. The method of claim 23 wherein the distorting includes projecting the adjusted presentation onto a plane.

25. The method of claim 24 wherein the at least one parameter includes a direction for a perspective projection for the distortion function.

26. The method of claim 24 wherein the at least one parameter includes at least one of: a magnification for the region; a size for the focal region; a size for the shoulder region; a shape for the focal region; a shape for the shoulder region; a location for the region within the original image; a location for the should region within the original image; and, a location for the focal region relative to the shoulder region.

27. The method of claim 26 wherein the GUI includes at least one of: a slide bar icon for selecting the at least one parameter for adjusting the magnification for the region; a bounding rectangle icon with at least one handle icon for selecting the at least one parameter for adjusting the size and the shape for the focal region; a bounding rectangle icon with at least one handle icon for selecting the at least one parameter for adjusting the size and the shape for the shoulder region; a move icon for selecting the at least one parameter for adjusting the location for the region within the original image; a pickup icon for selecting the at least one parameter for adjusting the location for the shoulder region within the original image; and, a fold icon for selecting the at least one parameter for adjusting the location for the focal region relative to the shoulder region.

28. The method of claim 23 wherein the original image includes a two-dimensional image and a three-dimensional model.

29. The method of claim 23 wherein the position tracking device is an eye tracking device.

30. The method of claim 24 wherein the position tracking device is an eye tracking device and wherein the signal includes a depth for the distortion function proportional to a focal depth for the user measured by the eye tracking device.

31. The method of claim 23 wherein the screen includes a remote screen coupled to the computer system by a network.

32. A method for generating a detail-in-context presentation for an original image for display on a screen of a computer system, comprising:
receiving a signal from a user through a position tracking device coupled to the computer system to initiate the generation of the presentation; and,
distorting the original image to produce the presentation, the presentation having a distorted region to provide the user with detailed information for a region of the original image;
wherein the signal includes a location for the distorted region within the original image and a direction for a perspective projection for the distorted region.

33. The method of claim 32 wherein the distorting further includes:
establishing a lens surface for the distorted region; and, transforming the original image by applying a distortion function defining the lens surface to the original image.

34. The method of claim 33 wherein the transforming includes projecting the adjusted presentation onto a plane.

35. The method of claim 33 wherein the establishing further includes displaying a graphical user interface (“GUI”) over the distorted region for adjusting the lens surface by the user with the position tracking device.

36. The method of claim 35 wherein the lens surface includes a focal region and a shoulder region and the GUI includes at least one of: a slide bar icon for adjusting a magnification for the lens surface; a bounding rectangle icon with at least one handle icon for adjusting a size and a shape for the focal region; a bounding rectangle icon with at least one handle icon for adjusting a size and a shape for the shoulder region; a move icon for adjusting a location for the lens surface within the original image; a pickup icon for adjusting a location for the shoulder region within the original image; and, a fold icon for adjusting a location for the focal region relative to the shoulder region.

37. The method of claim 32 wherein the original image includes a two-dimensional image and a three-dimensional model.

38. The method of claim 32 wherein the position tracking device is an eye tracking device.

39. The method of claim 34 wherein the position tracking device is an eye tracking device and wherein the signal includes a depth for the lens surface within the original image proportional to a focal depth for the user measured by the eye tracking device.

40. The method of claim 32 wherein the screen includes a remote screen coupled to the computer system by a network.
